(19) United States
(12) Patent Application Publication
(10) Pub. No.: US 2026/0017851 A1
(43) Pub. Date: Jan. 15, 2026

(54) SYSTEM AND METHOD FOR ELECTROMAGNETIC INVERSE SCATTERING IMAGE RECONSTRUCTION

(71) Applicant: Hong Kong Baptist University, Hong Kong (HK)

(72) Inventors: Renjie WAN, Hong Kong (HK); Ziyuan LUO, Hong Kong (HK)

(21) Appl. No.: 19/262,114

(22) Filed: Jul. 8, 2025

Related U.S. Application Data
(60) Provisional application No. 63/669,702, filed on Jul. 11, 2024.

(51) Int. Cl. G06T 11/00; G06N 3/0985

(52) U.S. Cl. CPC G06T 11/006; G06N 3/0985; G06T 2211/424

(57) ABSTRACT

A system for inverse scattering image reconstruction using implicit neural representations (INR) is provided. The system comprises a transmitter control module, a receiver acquisition module, a random spatial sampling module, a permittivity representation module implemented using a first multilayer perceptron (MLP), an induced current representation module implemented using a second MLP, a forward simulation module, a loss computation module, and an optimization module. The system is configured to emit electromagnetic signal data toward a target object, collect scattered signal data, simulate forward electromagnetic propagation, and iteratively update the MLP parameters using loss feedback. Upon convergence, the system outputs a spatial distribution of relative permittivity values to reconstruct the internal structure of the target object.

### CROSS-REFERENCE TO RELEVANT APPLICATIONS

The present application claims priority from a U.S. provisional patent application Ser. No. 63/669,702 filed Jul. 11, 2024, and the disclosure of which is incorporated by reference in its entirety.

### TECHNICAL FIELD

The present invention relates to electromagnetic imaging technologies, particularly to systems and methods for inverse scattering image reconstruction using implicit neural representations (INR).

### BACKGROUND

As electromagnetic waves are capable of penetrating the surfaces of objects, they are utilized as a key modality for non-invasive imaging. Compared with imaging modalities such as X-ray and MRI, electromagnetic waves offer a potentially low-cost and safe alternative for non-invasive imaging. Non-invasive imaging using electromagnetic waves is accomplished by solving Electromagnetic Inverse Scattering Problems (EISP). In EISP, the distribution of the scatterer's relative permittivity is inferred from the measured scattered fields. The relative permittivity values are subsequently visualized to reconstruct the internal structures of the object.

However, solving EISP remains a challenging task. A primary difficulty arises from the inverse estimation process, during which the scatterer's relative permittivity must be derived from the measured scattered fields. Multiple scattering effects inherent to EISP further complicate this inverse estimation. Additionally, continuous spaces are typically discretized into finite elements or grids to facilitate numerical electromagnetic computations. Such discretization inherently results in loss of details and reduced image resolution, making it difficult to accurately distinguish small internal structures located in close proximity. As the scattering mechanism strongly influences the solution of EISP, recent deep-learning-based methods have sought to address these challenges by first generating a rough image using traditional algorithms and then refining it through image-to-image translation networks. However, the division of the imaging process into two distinct stages leads to the physical measurement data being overlooked in the second phase, resulting in inferior image quality. Moreover, because the distribution of relative permittivity can vary substantially among different objects, a single network may not be adequate to capture these variations. As a result, an object-specific optimization approach that fully accounts for the scattering mechanisms is needed. Traditional methods, such as Twofold SOM and Gs SOM, attempt to achieve this by discretizing continuous relative permittivity values into matrices to be optimized.

Nonetheless, such methods are unable to resolve the low-resolution limitations introduced by discretization and often perform poorly when confronted with sparse measurement data, resulting in low-quality reconstructions.

Because the scatterer's relative permittivity distribution is intimately associated with spatial coordinates, it is necessary for an effective approach to capture this location-dependent property. Moreover, to enhance imaging quality, it is essential to overcome the low-resolution limitations introduced by discretization. Therefore, there is a need for an approach capable of representing the relative permittivity distribution in a continuous manner while preserving fine spatial details and enabling high-resolution reconstruction.

### SUMMARY OF INVENTION

It is an objective of the present invention to provide a system and a method to address the aforementioned issues in the prior arts.

Electromagnetic Inverse Scattering Problems (EISP) have gained wide applications in computational imaging. By solving EISP, the internal relative permittivity of the scatterer can be non-invasively determined based on the scattered electromagnetic fields. Despite previous efforts to address EISP, achieving better solutions to this problem has remained elusive, due to the challenges posed by inversion and discretization. In the present disclosure, the proposed solution tackles those challenges in EISP via an implicit approach. By representing the scatterer's relative permittivity as a continuous implicit representation, the proposed method is able to address the low-resolution problems arising from discretization. Further, optimizing this implicit representation within a forward framework allows us to conveniently circumvent the challenges posed by inverse estimation. The proposed approach outperforms existing methods on standard benchmark datasets.

In the present invention, the scatterer's relative permittivity distribution via Implicit Neural Representations (INR) is introduced, as INR has remarkable capability in modeling location-dependent relationships. INR's flexibility in handling image resolutions also helps to alleviate the curse made by discretization. Besides, INR is known for its case-by-case optimization strategy, which can faithfully reflect each object's internal differences. In addition, INRs exhibit a strong capacity to recover information from incomplete data across a range of tasks, which can address the difficulties caused by sparse measurement. The INR of each object is optimized by making sure that this representation can produce results akin to the actual measurements. Such an optimization based on forward estimation can help to address the difficulties caused by inverse estimation. Once the optimization settles down, the relative permittivity values can be accessed by using their corresponding locations and visualize them for imaging purposes.

In accordance with a first aspect of the present invention, a system for inverse scattering image reconstruction using INR is provided. The system includes a transmitter control module, a receiver acquisition module, a random spatial sampling module, a permittivity representation module, an induced current representation module, a forward simulation module, a loss computation module, and an optimization module. The transmitter control module is configured to emit known electromagnetic signal data directed toward a target region containing a target object. The receiver acquisition module is configured to collect scattered signal data resulting from interactions between the known electromagnetic signal data and internal features of the target object. The random spatial sampling module is configured to generate spatial coordinate data distributed across the target region. The permittivity representation module is configured to receive the spatial coordinate data and output relative permittivity data, in which the permittivity representation module is implemented using a first multilayer perceptron (MLP). The induced current representation module is configured to receive the spatial coordinate data and transmitter location data and to output induced current data, wherein the induced current representation module is implemented using a second MLP. The forward simulation module is configured to receive the relative permittivity data and the induced current data and to generate predicted scattered signal data at multiple receiver locations. The loss computation module is configured to compare the predicted scattered signal data with the scattered signal data collected by the receiver acquisition module and to compute a data loss. The optimization module is configured to receive the data loss and to iteratively update internal parameters of the first and second MLPs via a gradient-based optimization process, in which, upon convergence, the first MLP within the permittivity representation module is configured to output a spatial distribution of relative permittivity values representing an internal structure of the target object.

In accordance with a second aspect of the present invention, a method for inverse scattering image reconstruction using INR is provided. The method includes step as follows: emitting known electromagnetic signal data directed toward a target region containing a target object by a transmitter control module; collecting scattered signal data resulting from interactions between the known electromagnetic signal data and internal features of the target object by a receiver acquisition module; generating spatial coordinate data distributed across the target region by a random spatial sampling module; receiving the spatial coordinate data and accordingly outputting relative permittivity data by a permittivity representation module which is implemented using a first MLP; receiving the spatial coordinate data and transmitter location data and accordingly outputting induced current data by an induced current representation module which is implemented using a second MLP; receiving the relative permittivity data and the induced current data and accordingly generating predicted scattered signal data at multiple receiver locations by a forward simulation module; comparing, by a loss computation module, the predicted scattered signal data with the scattered signal data collected by the receiver acquisition module, thereby computing a data loss; receiving the data loss and iteratively updating internal parameters of the first and second MLPs via a gradient-based optimization process by using an optimization module; and outputting, by the first MLP within the permittivity representation module, a spatial distribution of relative permittivity values representing an internal structure of the target object upon convergence.

By the above configuration, the inventive proposed solution can provide contributions at least summarized as follows:
1) proposing a solution to EISP based on forward estimation to avoid difficulties triggered by inverse estimation;
2) introducing the use of the learnable INR for the object's relative permittivity distribution to indicate the location-dependent quantity and achieve flexibility in imaging resolution; and
3) exploring a novel strategy that utilizes two separate MLPs for two physical quantities to avoid complex computations caused by matrix inversion.

Moreover, the research for solving EISP has established standard benchmarks for evaluation, and, in the present disclosure, the standard benchmarks, including system settings, datasets, and metrics, are strictly followed in the conducted research.

### BRIEF DESCRIPTION OF DRAWINGS

Embodiments of the invention are described in more details hereinafter with reference to the drawings, in which:

FIG. 1 shows results of a standard test case in Electromagnetic Inverse Scattering Problems (EISP);

FIG. 2 shows overview of an implicit method according to some embodiments of the present invention;

FIG. 3 shows samples obtained from synthetic Circular-cylinder dataset and MNIST dataset;

FIG. 4 shows samples obtained from real-world Institut Fresnel's database;

FIG. 5 shows samples obtained under 5% and 30% noise levels;

FIG. 6 shows comparison of resolution flexibility among different methods;

FIG. 7 illustrates Table 1, which summarizes the quantitative results of reconstruction quality for the proposed method;

FIG. 8 shows the results for sparse measurement;

FIG. 9 shows the results for 3D scenarios on 3D MINIST dataset;

FIG. 10 provides Table 2, which presents a comparison of iteration efficiency between the proposed model and a single-MLP baseline;

FIG. 11 shows positions of the transmitters and receivers on the measurement circle for synthetic datasets;

FIG. 12 shows the ground truth of FoamDielExt, FoamDielInt, and FoamTwinDiel scenarios in Institut Fresnel's database;

FIG. 13 shows positions of the transmitters and receivers on the measurement circle for Institut Fresnel's database;

FIG. 14 shows positions of the transmitters and receivers on the measurement sphere for 3D dataset;

FIG. 15 illustrates a pseudocode that provides a detailed, step-by-step representation of the proposed approach;

FIG. 16 shows ablation study results including comparison with different backbones and comparison with and without variation loss LTV;

FIG. 17, FIG. 18, FIG. 19, and FIG. 20 present additional qualitative and quantitative results on the Circular-cylinder dataset and MNIST dataset under varying noise levels;

FIG. 21 is a schematic diagram illustrating a system performing its task and producing an output result according to one embodiment of the present invention; and

FIG. 22 is a block diagram illustrating an architecture of a system for inverse scattering image reconstruction using INR according to one embodiment of the present invention.

### DETAILED DESCRIPTION OF THE INVENTION:

In the following description, systems and methods for inverse scattering image reconstruction using implicit neural representations (INR) and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The description for a physical model of EISP is provided below.

### I: Physical Model

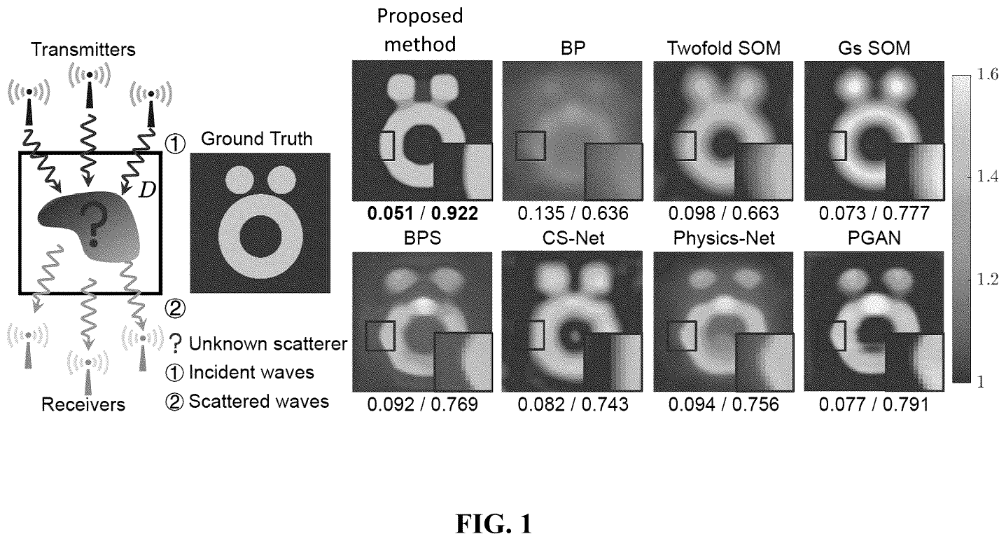

FIG. 1 shows results of a standard test case in Electromagnetic Inverse Scattering Problems (EISP). In an EISP system, the scatterer in the enclosed space D is first illuminated by incoming electromagnetic waves emitted by transmitters and generates scattered fields. Then, the scattered fields measured by receivers are used to determine the scatterer's relative permittivity. In the illustration, there are results obtained by the method proposed by the invention, BP, Twofold SOM, Gs SOM, BPS, CS-Net, Physics-Net, and PGAN. The pixel values in the images indicate the values of the relative permittivity. RRMSE/SSIM values are shown below each figure.

As shown in FIG. 1, for an EISP system, the object to be imaged is defined as the unknown scatterer and the enclosed space is represented by a square Region of Interest (ROI) denoted by “D.” Transmitters and receivers are positioned around the enclosed space D to emit electromagnetic waves and measure the scattered electromagnetic fields, respectively.

Generally, the data measurement process can be split into two stages. At the first stage, the induced current is excited as the electromagnetic waves from the transmitters interact with the scatterer, aka wave-scatterer interaction. Subsequently, the induced current serves as a radiation source, generating the scattered fields. The total electric fields within the enclosed space D can be described by the Lippmann-Schwinger equation, as known as state equation, as follows:

$${E}^{t} ( x ) = {E}^{i} ( x ) + {k}_{0}^{2} \int g ( x , {x}^{′} ) J ( {x}^{′} ) {dx}^{′} \qquad Eq . ( 1 )$$

where x and x′ are the spatial coordinates. Eⁱ is the incident electric fields directly from transmitters, while E^{t} is the total electric fields consisting of the original incident fields coming directly from transmitters and the scattered fields coming from scatterers. k₀ is the wavenumber computed from the signal frequency, and g is the free space Green's function. The relationship between the induced current J and total electric fields E^{t} can be expressed as follows:

$$J ( X ) = ξ ( x ) {E}^{t} ( x ) \qquad Eq . ( 2 )$$

In Eq. (2), ξ is the contrast defined as ξ(x)=εᵣ(x)−1, where εᵣ(x) denotes the relative permittivity of the unknown scatterer.

The second equation describes the scattered fields as a reradiation of the induced current, as known as data equation below:

$${E}^{s} ( x ) = {k}_{0}^{2} {\int }_{D} g ( x , {x}^{′} ) J ( {x}^{′} ) {dx}^{′} , x ∈ S \qquad Eq . ( 3 )$$

where E^{s} is the scattered fields that can be measured by receivers at surface S around the ROI D.

Since the digital signal analysis is only available on discrete variables, Eq. (1) to Eq. (3) are inevitably transformed to their discrete counterparts. Specifically, the ROI D is discretized into M×M square subunits, and the method of moments is employed to obtain the discrete scattered fields. The relationship between discrete contrast ξ and discrete relative permittivity εᵣ can be expressed as ξ=εᵣ−1. Then, Eq. (1) can be reformulated as follows:

$${E}^{t} = {E}^{i} + {G}_{D} \cdot J \qquad Eq . ( 4 )$$

where E^{t}, Eⁱ, and J are the discrete E^{t}, Eⁱ, and J, respectively. G_{D} is discrete free space Green's function in D. The discrete version of Eq. (2) can be represented as follows:

$$J = Diag ( ξ ) \cdot {E}^{t} \qquad Eq . ( 5 )$$

where Diag(ξ) is the diagonal matrix of the contrast function. Similarly, Eq. (3) can be discretized as follows:

$${E}^{s} = {G}_{S} \cdot J \qquad Eq . ( 6 )$$

where E^{s} is the discrete E^{s}, and G_{S} is the discrete Green's function to map contrast source J to scattered fields E^{s}.

The task of EISP is to infer the relative permittivity εᵣ, a value closely related to ξ, from the scattered fields Es measured by receivers and then visualize it in an image. In an EISP system, knowing only Eⁱ and E^{s} makes it challenging to estimate ξ inversely from E^{s} based on Eq. (6). Furthermore, the inherent nonlinearity originating from G_{D}· and J in Eq. (4) complicates the estimation process. Ultimately, εᵣ, a variable with continuous characteristics, can only be derived using the aforementioned discrete equations, thereby compromising the imaging resolution. Consequently, an effective strategy is necessary to produce more accurate outcomes for EISP. More details about this part can be found in the appendix section of the supplementary material.

The description for an implicit solution is provided below.

### II: Implicit Solution

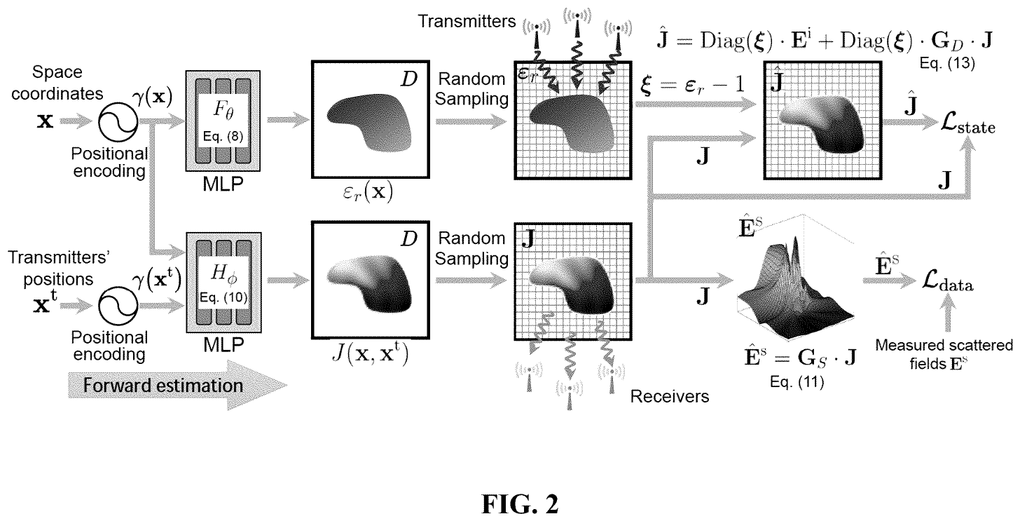

FIG. 2 shows overview of an implicit method according to some embodiments of the present invention. Two multilayer perceptrons (MLPs), F_{θ} and H_{ϕ}, are used to implicitly represent relative permittivity εᵣ and induced current J, respectively. Random sampling is applied for comprehensive optimization. The predicted induced current Ĵ is calculated by Eq. (13) based on relative permittivity εᵣ queried from F_{θ} and induced current J directly queried from H_{ϕ}. Then the state loss Lₛₜₐₜₑ is calculated by comparing the predicted Ĵ and directly queried J. Besides, the directly queried induced current J is used to compute the scattered fields Ê^{s} by Eq. (11). Data loss function L_{data} is constructed to evaluate the difference between predicted scattered fields Ê^{s} and the measured values E^{s}.

In the present invention, the MLP serves as the backbone of INR. Specifically, two MLPs are used to represent the relative permittivity and the induced current. It allows us to bypass complex matrix inversions in optimization, largely reducing the computational cost. To optimize the implicit representations, a data loss and a state loss are proposed by fully considering the relationships between various physical quantities in the scattering process. Meanwhile, a random sampling strategy is designed for comprehensive consideration of each spatial position during optimization.

As depicted in FIG. 2, the fundamental core solution is to solve the inverse scattering problem within a forward estimation process, which can be described by reformulating Eq. (4) to Eq. (6) as follows:

$${E}^{s} = {G}_{S} \cdot Diag ( ξ ) \cdot {( I - {G}_{D} Diag ( ξ ) )}^{- 1} \qquad Eq . ( 7 )$$

where I is the identity matrix. Contrary to other approaches that treat ξ as unknown, the contrast ξ is taken as a known quantity by establishing relative permittivity εᵣ involved in Eq. (2) as a learnable implicit representation. Then, E^{s} can be calculated with triggered by Eq. (7). During training, by contrasting the calculated E^{s} with the measured true ones, the learnable representation can finally reach its optimum status. Since the proposed solution does not aim to inversely express ξ as an explicit function of E^{s}, this optimization-in-forward approach can alleviate the challenges associated with inverse estimation and nonlinearity. The use of INR also ensures enhanced flexibility in imaging resolution. During inference, the relative permittivity values can be directly obtained by querying the representation with the corresponding coordinates.

### The Implicit Solution—Continuous Representation for EISP

Representation for relative permittivity: A MLP with parameters θ is used to map the continuous spatial coordinates x to its associating relative permittivity values, which can be briefly described as follows:

$${ε}_{r} ( x ) = {F}_{θ} ( γ ( x ) ) \qquad Eq . ( 8 )$$

where εᵣ denotes the relative permittivity obtained by querying the spatial coordinates within the continuous representation F_{θ}. The position encoding for x is applied to facilitate the fitting capability of the model as follows:

$$γ ( x ) = {[ sin x , cos x , … , sin {2}^{Ω - 1} x , cos {2}^{Ω - 1} x ]}^{Τ} \qquad Eq . ( 9 )$$

where Ω is a hyperparameter controlling the spectral bandwidth.

To optimize this continuous representation, a series of equations defined by the computation of forward estimation is applied and then the scattered fields incited by this representation are compared with the measured true ones. As the previous discussion, since discretization is unavoidable during the forward computation, only discrete spatial coordinates are queried during optimization to align with the discretization policy set by the method of moments. Although the forward computation can be directly performed via Eq. (7), the computational complexity arising from internal matrix inversion places a high demand on computing resources and potentially compromises the stability of problem-solving.

Representation for induced current: To avoid the complexity caused by matrix inversion, instead of the explicit computation defined in Eq. (7), the induced current J is implicitly represented in continuous form using another MLP. By analyzing Eq. (7), the induced current is related to two variables: the discrete contrast ξ and the incident electric fields Eⁱ caused by transmitters. To faithfully describe such correlation, the representation for J might be considered as the mapping based on the spatial coordinates x and the transmitter's position x^{t}, which can be defined as follows:

$$J ( x , {x}^{t} ) = {H}_{ϕ} ( γ ( x ) , γ ( {x}^{t} ) ) \qquad Eq . ( 10 )$$

where H_{ϕ} is a continuous function consisting of fully connected networks.

Random spatial sampling: Due to the necessity of discretization in numerical computations to perform forward process, it is needed to spatially query the representations F_{θ} and H_{ϕ} at some positions to obtain their discrete forms. One of approached is to divide the ROI D evenly into grids and deterministically sample the center location of each grid. However, the representations would only be queried at a fixed discrete set of locations in this way. To take a comprehensive consideration of each spatial position, a random sampling scheme is used where ROI D is partitioned into M×M evenly-spaced grids and the center of (m, n) grid is (xₘ, yₙ). Each sample location (x^{sample}, y^{sample}) is then randomly drawn from a Gaussian distribution: x^{sample}˜N (xₘ, σ²), y^{sample}˜N (yₙ, σ²), where σ is a hyperparameter to control the dispersion level of sample points around their means. By probabilistically sampling each spatial position, this scheme can alleviate the overlook of specific locations.

### The Implicit Solution—Forward Calculation Based Optimization

The continuous representations obtained before can estimate corresponding physical quantities using spatial coordinates, but optimizing them directly with estimated values is hard because obtaining their true values is difficult. Therefore, the representations denoted by F_{θ} and H_{ϕ} are indirectly refined by introducing a data loss and a state loss while fully considering the physical relationships.

Data loss: Based on the previous discussion the wave-scatterer interaction leads to the induced current when the electromagnetic waves from transmitters interact with the scatterer. Then, the induced current generates the scattered fields, which can be measured by receivers. Thus, a straightforward way to refine the representations is to minimize the distance between the scattered fields computed from the representations and the true ones. With the discrete induced current J sampling from the continuous representation H_{ϕ} defined in Eq. (10), the predicted scattered fields can be obtained by reformulating the data equation in Eq. (6) as follows:

$${\hat{E}}_{p}^{s} = {G}_{S} \cdot {J}_{p} \qquad Eq . ( 11 )$$

where Gₛ denotes the discrete Green's function, and Jₚ and Ê^{s} denote the discrete induced current and predicted scattered fields inspired by the p-th transmitter, respectively.

The data loss used to contrast the predicted scattered fields with the measured true fields is defined as follows:

$${ℒ}_{data} = {\sum }_{p = 1}^{{N}_{t}} {‖ {\hat{E}}_{p}^{s} - {E}_{p}^{s} ‖}^{2} \qquad Eq . ( 12 )$$

where E^{s} is the true scattered fields measured by receivers, and Nₜ denotes the number of all transmitters. The data loss enhances the optimization of the representation by accounting for discrepancies associated with all transmitters.

Regarding state loss, although the data loss is straightforward, it cannot be used to optimize F_{θ}. Since the induced current Jₚ is directly obtained by querying its representation H_{ϕ}, Eq. (12) does not contain any variables related to F_{θ}. To effectively optimize F_{θ}, it is considered of minimizing the mismatch emerging from the state equation defined in Eq. (4) and Eq. (5). Specifically, by reformulating Eq. (7), an expression related to p-th transmitter can obtained as follows:

$${\hat{J}}_{p} = Diag ( ξ ) \cdot {E}_{p}^{i} + Diag ( ξ ) \cdot {G}_{D} \cdot {J}_{p} \qquad Eq . ( 13 )$$

where Jₚ denotes the discrete induced current sampling from H_{ϕ}, ξ denotes the contrast, and Ĵₚ indicates the induced current computed via the above mathematical correlation.

Although Jₚ and Ĵₚ originate from distinct sources, both represent the induced current values within the same spatial domain. If the same spatial coordinates are given, they should yield identical values irrespective of their generation sources. Therefore, a state loss is introduced to minimize the mismatch between Jₚ and Ĵₚ as follows:

$${ℒ}_{state} = {\sum }_{p = 1}^{{N}_{t}} {‖ {\hat{J}}_{p} - {J}_{p} ‖}^{2} \qquad Eq . ( 14 )$$

where Nₜ is the number of all transmitters. Since Eq. (2) has clearly defined the close correlation between ξ and the permittivity values εᵣ, the minimization of the state loss can ultimately optimize F_{θ} and H_{ϕ} used for representing the relative permittivity and induced current, respectively.

Overall loss: The overall loss is configured to train the relative permittivity representation F_{θ} and induced current representation H_{ϕ} can be obtained as follows:

$$ℒ = {λ}_{data} {ℒ}_{data} + {λ}_{state} {ℒ}_{state} + {λ}_{TV} {ℒ}_{TV} \qquad Eq . ( 15 )$$

where [symbol] is a total variation loss for ξ, and λ_{data}, λₛₜₐₜₑ, λ_{TV} are hyperparameters to balance the loss functions. The pseudocode of the proposed approach can be found in the descriptions of the supplementary material.

### The Implicit Solution—Implementation Details

The proposed method is implemented using PyTorch. Two eight-layer MLPs with 256 channels and ReLU activations are used to predict the relative permittivity εᵣ and induced current J, respectively. Positional encoding is applied to input positions before they are passed into the MLPs. The ROI D is discretized into 64×64 while training. The hyperparameters for the overall loss are set as λ_{data}=1.00, λₛₜₐₜₑ=1.00, and λ_{TV}=0.01. The Adam optimizer with default values β₁=0.9, β₂=0.999, ϵ=10⁻⁸ is applied, and a learning rate 5×10⁻⁴ that decays following the exponential scheduler during the optimization. The model for 4K iterations can be optimized on a single GPU for all the datasets. More details about the implementation can be found in the supplementary material.

### III: Experiments

### Experiments—Experiment Setup

Dataset: The model is trained and tested on standard benchmarks used for EISP. 1) A Synthetic Circular-cylinder dataset is synthetically generated comprising 1200 images of cylinders with random relative radius location and permittivity between 1 and 1.5. 2) Synthetic MNIST dataset contains grayscale images of handwritten digits. A total of 1200 samples are randomly selected to synthesize scatterers with relative permittivity values between 2 and 2.5 according to their corresponding pixel values. In order to generate the above two synthetic datasets, 16 transmitters and 32 receivers equally placed on a circle for regular settings are used, and the data are generated numerically using the method of moments with a 224×224 grid mesh to avoid inverse crime. For sparse measurement experiments, the number of receivers is decreased from 32 to 8 to utilize only 25% of the regular measurement data. 3) Real-world Institut Fresnel's database contains three different dielectric scenarios, namely FoamDielExt, FoamDielInt, and FoamTwinDiel. There are 8 transmitters for FoamDielExt and FoamDielInt, 18 transmitters for FoamTwinDiel, and 241 receivers for all the cases. As the wavelength of the emitted electromagnetic wave should be comparable to or smaller than the size of the target object, an operating frequency f=400 MHz is set on synthetic datasets and f=5 GHz is set on real-world datasets. More details about the dataset can be found in the supplementary material.

Baselines: The same settings as those used in other studies are maintained to ensure a fair comparison. The proposed method is compared with three traditional methods and four deep learning-based approaches. 1) BP: A traditional non-iterative inversion algorithm. 2) Twofold SOM: A traditional iterative minimization scheme by using SVD decomposition. 3) Gs SOM: A traditional subspace-based optimization method that decomposes the operator of Green's function. 4) BPS: A CNN-based image translation method with an initial guess from the BP algorithm. 5) CS-Net: A CNN-based contrast source reconstruction scheme via subspace optimization. 6) Physics-Net: A CNN-based approach that incorporates physical phenomena during training. 7) PGAN: A CNN-based approach using a generative adversarial network.

Evaluation methodology: It is to evaluate the quantitative performance of the proposed method using PSNR, SSIM, and Relative Root-Mean-Square Error (RRMSE). For PSNR and SSIM, a higher value indicates better performance. For RRMSE, a lower value indicates better performance. RRMSE is a metric widely used in EISP defined as follows: where εᵣ(m, n) and \hat{ε}ᵣ (m, n) are the true and reconstructed discrete relative permittivity of the unknown scatterers at location (m, n), respectively, and M×M is the total number of subunits over the ROI D.

### Experiments—Experiment Results

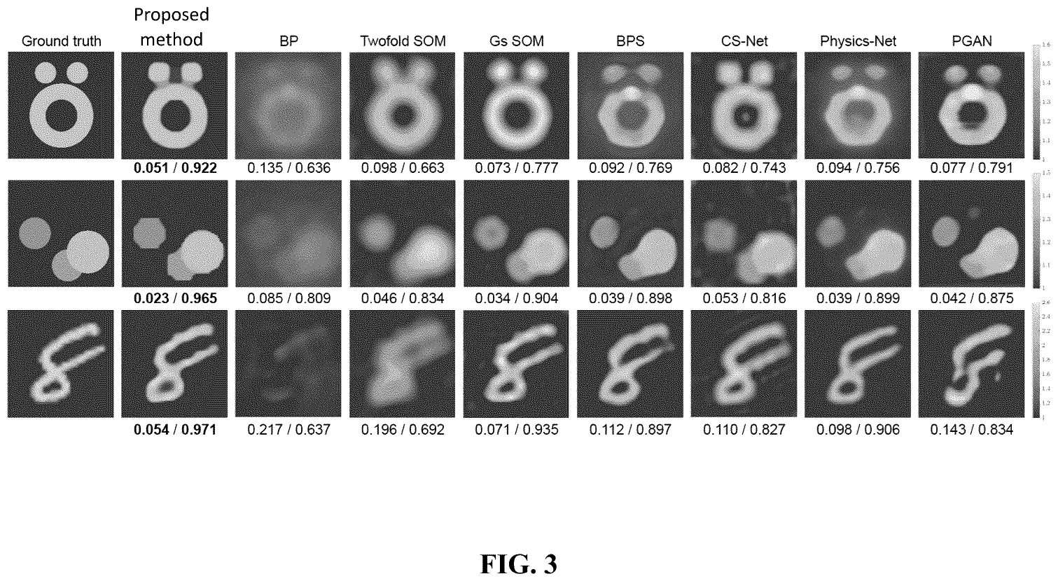

Qualitative results on synthetic data: The reconstruction quality is first compared visually using synthetic data, including the circular-cylinder dataset and the MNIST dataset, against all baselines, with the results shown in FIG. 3. FIG. 3 shows samples obtained from synthetic Circular-cylinder dataset and MNIST dataset. From left to right: ground truth, results obtained using the proposed method, BP, Twofold SOM, Gs SOM, BPS, CS-Net, Physics-Net, and PGAN. The pixel values in the images indicate the values of the relative permittivity. RRMSE/SSIM values are shown below each figure. The first row is a standard test case, a well-known pattern for the evaluation of EISP methods. The proposed method achieves superior visual performance compared to all other baselines. Traditional methods, such as BP and Twofold SOM, can only recover the rough shape of the target and produce inaccurate results at some junction parts. Gs SOM can reconstruct the relative permittivity of the targets with relatively high accuracy but still has obvious visual defects. Though deep learning-based methods, such as BPS, CS-Net, Physics-Net, and PGAN can produce more accurate estimations, their visual qualities are still far below the proposed method.

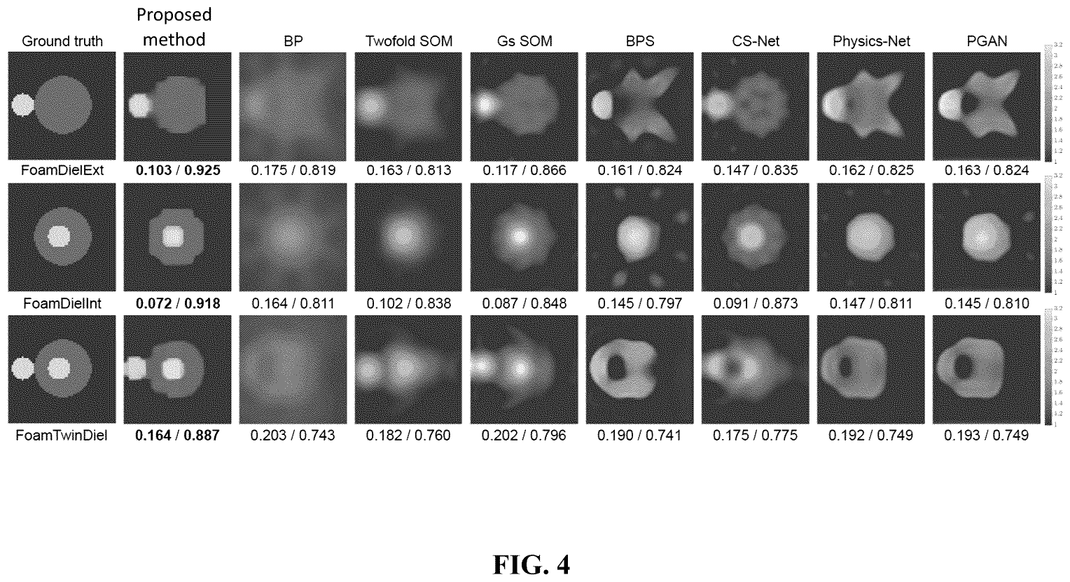

Qualitative results on real-world data: The proposed algorithm is tested on real-world data. The results for all methods are shown in FIG. 4. FIG. 4 shows samples obtained from real-world Institut Fresnel's database. From left to right: ground truth, results obtained using the proposed method, BP, Twofold SOM, Gs SOM, BPS, CS-Net, Physics-Net, and PGAN. The pixel values in the images indicate the values of the relative permittivity. RRMSE/SSIM values are shown below each figure. The visual performance of the proposed method remains superior when applied to real-world data. Conventional methods exhibit a diminished performance, which, when used as input, further negatively impacts the efficacy of deep learning-based approaches.

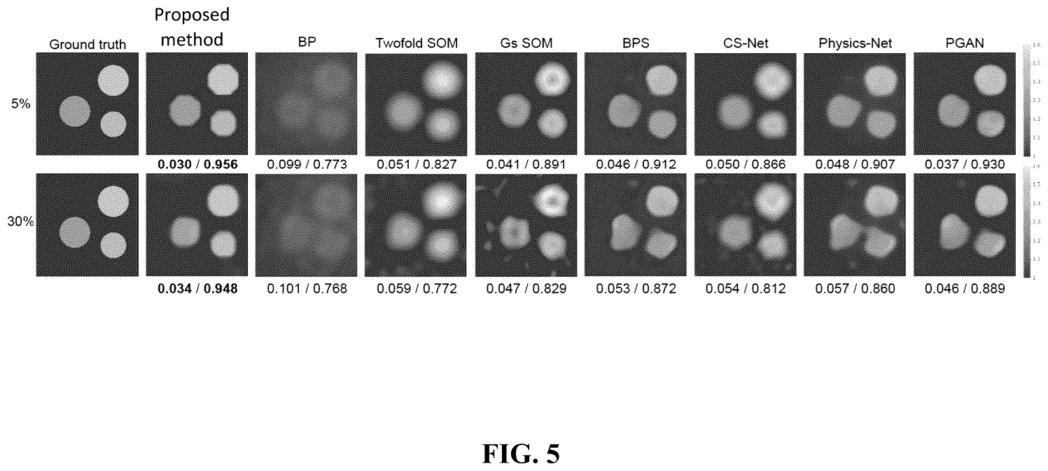

Noise robustness: The robustness of the models is also compared. By adding different levels of noise to the received scattered fields signal, the noisy scattered fields signal is used to recover the scattered object. The results are shown in FIG. 5. FIG. 5 shows samples obtained under 5% and 30% noise levels. From left to right: ground truth, results obtained using the proposed method, BP, Twofold SOM, Gs SOM, BPS, CS-Net, Physics-Net, and PGAN. The pixel values in the images indicate the values of the relative permittivity. RRMSE/SSIM values are shown below each figure. It can be observed that when large noise is added, the results of other baselines are greatly affected. However, the proposed method can accurately reconstruct the scatterer under larger noise, demonstrating the superior robustness of the proposed method.

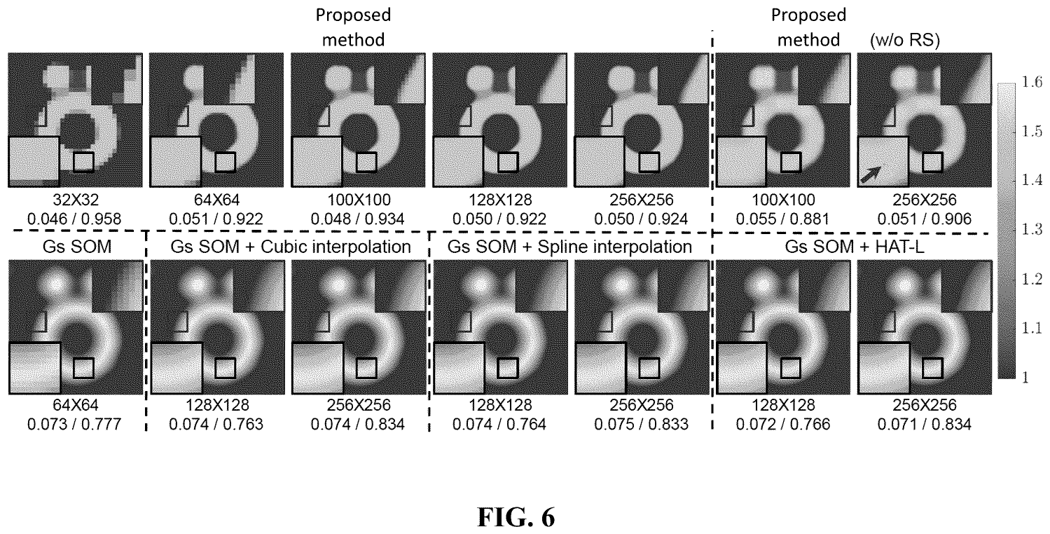

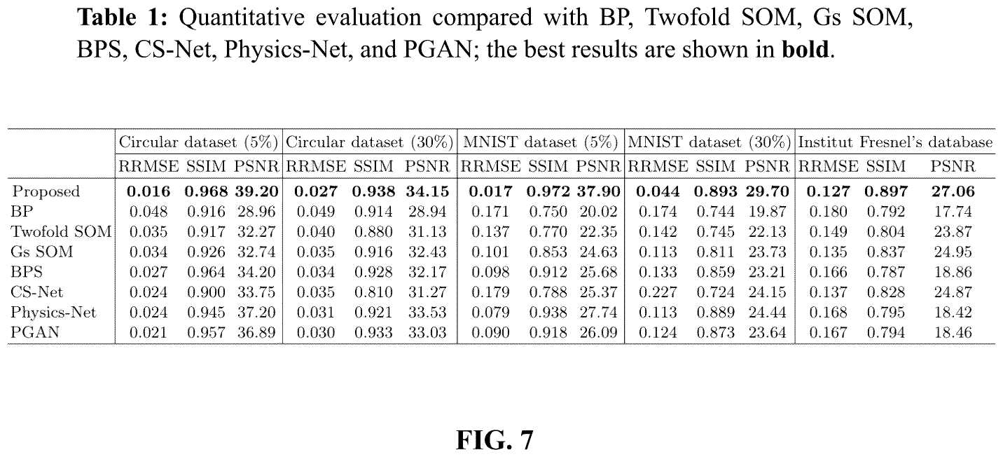

Evaluation for flexible resolution: The continuity of implicit function allows INR to interpolate and infer at arbitrary points in the input space. This characteristic ensures flexible resolution during the imaging process. FIG. 6 shows comparison of resolution flexibility among different methods. The proposed method is evaluated against the proposed method without random sampling (RS) scheme, Gs SOM, Gs SOM+Cubic/Spline interpolation, and Gs SOM+HAT-L, under different resolution settings. All methods are implemented at an original resolution of 64×64. The pixel values in the images indicate the values of the relative permittivity. Resolution and RRMSE/SSIM values are shown below each figure. As depicted in FIG. 6, a fixed resolution of 64×64 is employed during training and acquire images of varying resolutions by sampling the INR at different scales. The use of the random sampling scheme can avoid artifacts in the results. Compared to post-super-resolution methods, like Gs SOM+HAT-L, the proposed method can achieve higher quality results. The resolution flexibility of INR paves the way for more in-depth analysis of reconstructed images at various resolution levels.

Quantitative results: The quantitative results of the reconstruction quality in Table 1 of FIG. 7 further validate the proposed method. Higher PSNR and SSIM values suggest the proposed method accurately recovers object shapes and effectively maintains detailed structural information. Lower relative error values indicate the proposed method's predictions of relative permittivity distribution are more accurate compared to other methods.

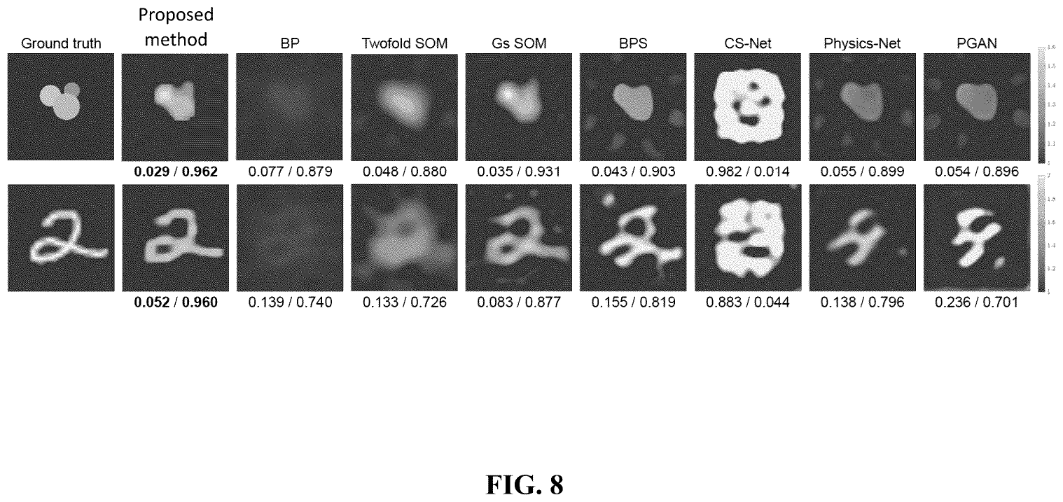

Results for sparse measurement: 25% of the standard measurement data is used to conduct an experiment, and the results are shown in FIG. 8. FIG. 8 shows the results for sparse measurement. From left to right: ground truth, results obtained using the proposed method, the BP, Twofold SOM, Gs SOM, BPS, CS-Net, Physics-Net, and PGAN. The pixel values in the images indicate the values of the relative permittivity. RRMSE/SSIM values are shown below each figure. The proposed method, leveraging INR, shows superior capability in reconstructing the object's interior from sparse measurements compared with other methods. This also demonstrates that INR is more suitable for representing the relative permittivity distribution of the object compared to other matrix-based representations like Twofold SOM and CS-Net.

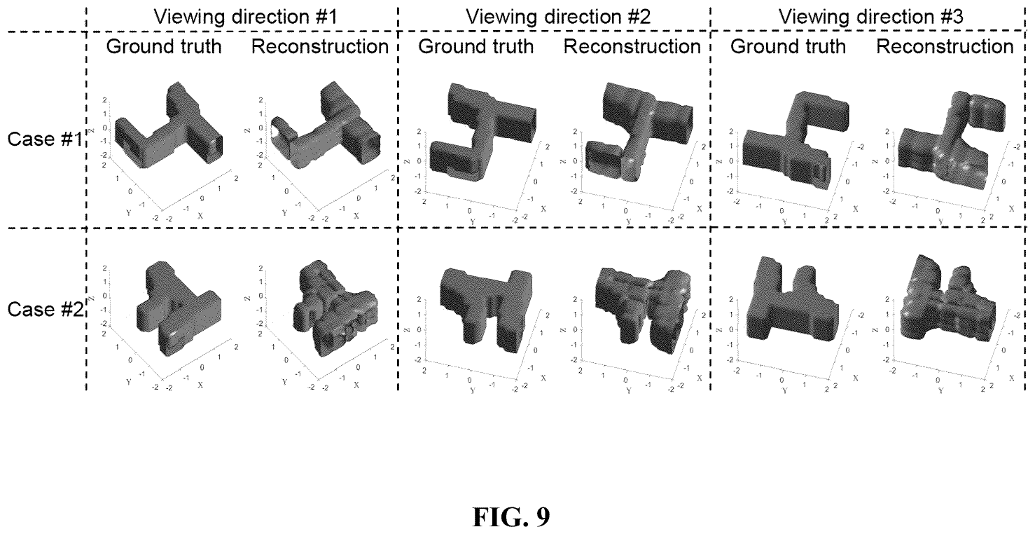

Results for 3D scenarios: The proposed method can naturally be generalized to 3D scenarios. In 3D scenarios, 3D Green's functions in Eq. (4) and Eq. (6) are utilized, and integration is performed over a 3D region of interest. The input dimension of the representations for relative permittivity and induced current is augmented to align with the 3D coordinates while the remaining structures are kept unchanged. The 3D scattering data are collected from the 3D MNIST dataset. In the experiments, 40 transmitters and 160 receivers are employed and arranged around a unit cube. The results shown in FIG. 9 demonstrate that the proposed method can reconstruct 3D objects by solving EISP. FIG. 9 shows the results for 3D scenarios on 3D MINIST dataset. Two example cases are shown with three viewing directions. Iso-surface is used to visualize the ground truths and reconstructed results of the spatial distribution of relative permittivity by setting the iso-value to 1.1.

### Experiments—Ablation Study

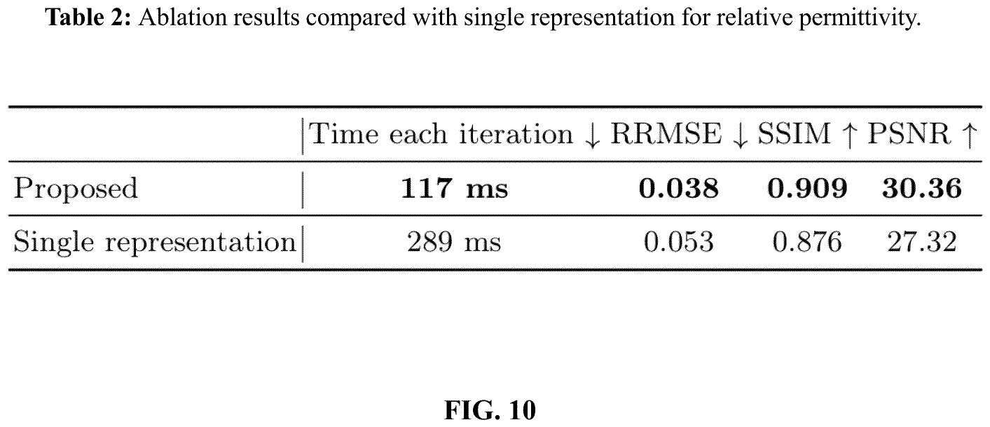

The proposed approach mainly consists of three parts: the representation for relative permittivity, representation for induced current, and random sampling. Since both the data loss L_{data} and the state loss Lₛₜₐₜₑ are necessary for the proposed method, none of them can be easily removed. A single representation for relative permittivity is first used to replace the two MLPs in the original approach. Both models are trained on a GPU. From the results shown in Table 2 of FIG. 10, the model with a single MLP takes a longer iteration time to achieve similar performance. The random sampling scheme is further removed and a uniform sampling approach is adopted. As shown in the last two columns in FIG. 6, results without random sampling have lower metric values, and the high-resolution results occasionally meet obvious artifacts.

### IV: Supplementary Material

### Supplementary Material—S1 Overview

This supplementary document provides more discussions, reproduction details, and additional results:

S2 discusses the detailed physical model of the Electromagnetic Inverse Scattering Problems (EISP); S3 provides details of the system settings for each dataset; S4 presents reproduction details and pseudocode of the proposed method; and S5 provides additional results, including ablation studies on different backbones and variation loss, and additional qualitative and quantitative results.

### Supplementary Material—S2.1 Detailed Physical Model of EISP

To clarify the physical model of the EISP, some key equations as afore-mentioned are recited again. The data equation describes the wave-scatterer interaction, which can be formulated as:

$${E}^{t} = {E}^{i} + {G}_{D} \cdot J \qquad Eq . ( S1 )$$

where E^{t}, Eⁱ, and J are the discrete total electric fields, incident electric fields, and induced current, respectively. G_{D} is discrete free space Green's function in Region of Interest (ROI) D. The relationship between the induced current J and total electric fields E^{t} can be described as:

$$J = Diag ( ξ ) \cdot {E}^{t} \qquad Eq . ( S2 )$$

where Diag(ξ) is the diagonal matrix of the contrast function. The contrast ξ is defined as:

$$ξ = {ε}_{r} - 1 \qquad Eq . ( S3 )$$

where εᵣ is the relative permittivity. The data equation describes the scattered field as a reradiation of the induced current, which can be expressed as:

$${E}^{s} = {G}_{S} \cdot J \qquad Eq . ( S4 )$$

where E^{s} is the discrete scattered field, and G_{S} is the discrete Green's function to map the induced current J to scattered field E^{s}.

The aim of forward estimation is to deduce the scattered fields E^{s} from given incident fields Eⁱ. The forward estimation is linear because E^{s} and Eⁱ have a linear relationship. Specifically, by replacing J in Eq. (S1) with Eq. (S2), it can be obtained that:

$${E}^{t} = {E}^{i} + {G}_{D} \cdot Diag ( ξ ) \cdot {E}^{t} \qquad Eq . ( S5 )$$

Reformulating Eq. (S5) yields the expression for total fields E^{t}:

$${E}^{t} = {( I - {G}_{D} Diag ( ξ ) )}^{- 1} \cdot {E}^{i} \qquad Eq . ( S6 )$$

By combining Eq. (S2), it can be obtained the expression of induced current J as:

$$J = Diag ( ξ ) \cdot {( I - {G}_{D} Diag ( ξ ) )}^{- 1} \cdot {E}^{i} \qquad Eq . ( S7 )$$

Then, the expression for the scattered fields E^{s} can be obtained from Eq. (S4) and Eq. (S7) as:

$${E}^{s} = {G}_{S} \cdot Diag ( ξ ) \cdot {( I - {G}_{D} Diag ( ξ ) )}^{- 1} \cdot {E}^{i} \qquad Eq . ( S8 )$$

Since Green's functions G_{D} and G_{S} are fixed in the described problem, and the contrast ξ, or relative permittivity εᵣ is the physical property independent of the incident fields, Eq. (S8) is a linear equation in variables E^{s} and Eⁱ. Therefore, it can be easily obtained the scattered fields E^{s} through Eq. (S8) if the relative permittivity εᵣ is known. The convenience and benefits of forward estimation are utilized to circumvent the difficulties associated with EISP.

### Supplementary Material—S2.2 Difficulties of EISP

Three main challenges of EISP are discussed herein with explanation why the proposed approach can address these challenges.

Inverse: in an inverse problem, the incident fields Eⁱ are given and the scattered fields E^{s} are measured by receivers, and then the task is to reconstruct relative permittivity εᵣ from the measured scattered fields. From Eq. (S3), this task is equivalent to predicting the contrast ξ. An intuitive approach is to infer the induced current J from the scattered field E^{s} by inverse deduction from Eq. (S4). However, the discrete Green's function is a complex matrix of dimension Nᵣ×M², where Nᵣ is the total number of receivers and M×M is the size of the discretized subunits of ROI. In practice, it is set as Nᵣ<<M². Since such a less-than relation does not provide enough information to determine J from Eq. (S4), it is difficult to obtain relative permittivity εᵣ by this inverse way.

Nonlinearity: The nonlinearity poses significant challenges to the solution of the EISP. Nonlinearity is explained from two perspectives. First, in Eq. (S8), the nonlinearity is due to the fact that the scattered fields E^{s} are not doubled when the scatterer's permittivity is doubled. This phenomenon is caused by the condition that total fields Et is a quantity related to the relative permittivity εᵣ according to Eq. (S6). Then, the nonlinearity is due to the multiple scattering effect that physically exists. In Eq. (S1), the global-effect term G_{D}·J is caused by multiple scattering effects, a factor leading to the nonlinearity. Traditional methods involve a linearization of the original problem by neglecting the effect of multiple scattering. However, these methods can introduce significant errors and compromise the accuracy of the computation when the multiple scattering amplitude is large and unignorable.

Discretization: Although the relative permittivity εᵣ exhibits continuous properties, numerical computations based on the aforementioned discrete equations can only obtain the discrete form of the relative permittivity with low resolution. Such a low resolution always makes it difficult to recognize the scatterer's details.

Why the proposed approach can address these challenges: An implicit forward solution is proposed for EISP. First, Implicit Neural Representations (INR) is applied to represent relative permittivity εᵣ and induced current J separately. Then, these two representations are optimized through forward estimation by constructing two loss functions, namely data loss L_{data} and state loss Lₛₜₐₜₑ. In this way, there is no need to worry about the difficulties caused by inverse estimation and nonlinearity. Besides, due to the inherent property of INR to approximate continuous functions, the proposed method can provide results with flexible resolutions.

### Supplementary Material—S3 Details of System Settings

Experiments are conducted on synthetic, real-world, and 3D datasets. Differences in system settings for each dataset are noted, and separate explanations are provided for each case.

### Supplementary Material—S3.1 Settings for Synthetic Datasets

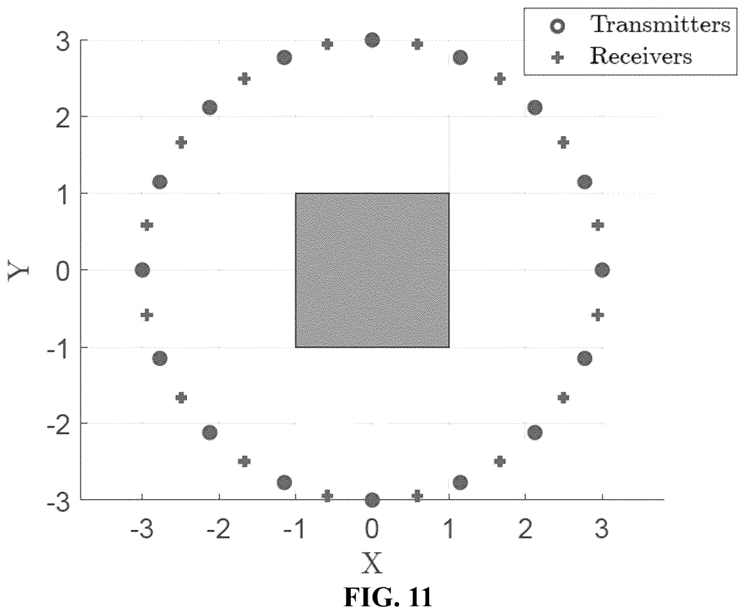

Two synthetic datasets, the Circular-cylinder dataset and the MNIST dataset, are used for the experiments in the present disclosure. The basic settings are the same for these two datasets. Parameters are set, including that operating frequency f=400 MHz and that the ROI is a square with the size of 2×2 m². The placement scheme for transmitters and receivers is illustrated in FIG. 11. FIG. 11 shows positions of the transmitters and receivers on the measurement circle for synthetic datasets. The central rectangular area indicates the ROI. There are 16 transmitters and 32 receivers equally placed on a circle of radius 3 m centered at the center of ROI.

### Supplementary Material—S3.2 Settings for Real-World Dataset

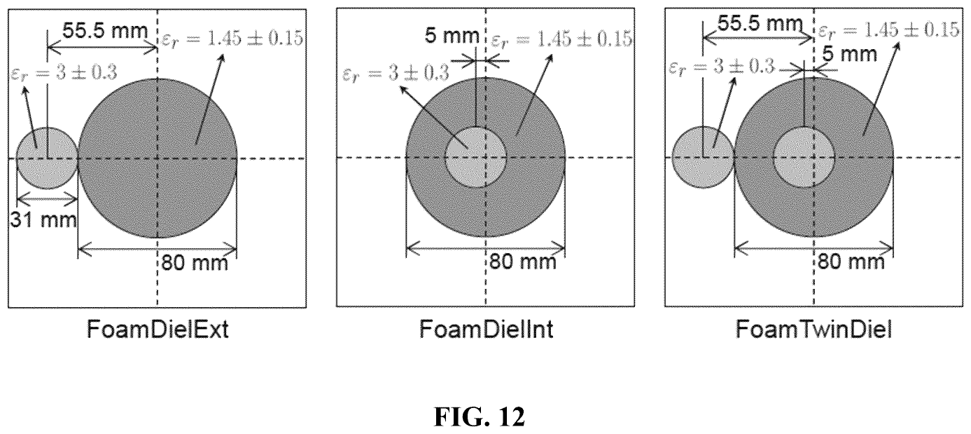

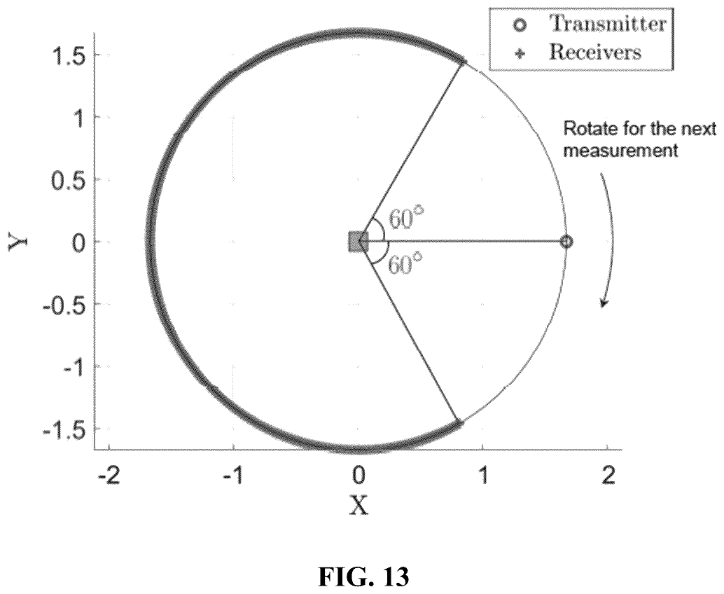

Institut Fresnel's database is a famous real-world electromagnetic scattering dataset in the field of EISP. FoamDielExt, FoamDielInt, and FoamTwinDiel scenarios are used in Institut Fresnel's database for testing. FIG. 12 shows the ground truth of FoamDielExt, FoamDielInt, and FoamTwinDiel scenarios in Institut Fresnel's database. As presented in FIG. 12, all the cases consist of two kinds of cylinders. The large cylinder (SAITEC SBF 300) has a diameter of 80 mm with the relative permittivity εᵣ=1.45±0.15. The small cylinder (berylon) has a diameter of 31 mm with the relative permittivity εᵣ=3±0.3. The “±” indicates the range of uncertainty associated with the experimental value. The operating frequencies are taken from 2 to 10 GHz with a step of 1 GHz. The ROI is a square with the size of 0.15×0.15 m². All the transmitters and receivers are equally placed on a circle of radius 1.67 m centered at the center of ROI. For all scenarios, 241 receivers are used for each measurement, with a central angle step of 1°, without any position closer than 60° from the transmitter. The placement schemes for FoamDielExt, FoamDielInt, and FoamTwinDiel are shown in FIG. 13. FIG. 13 shows positions of the transmitters and receivers on the measurement circle for Institut Fresnel's database. The central rectangular area indicates the ROI. After each measurement, the measurement system rotates by a certain angle for the next measurement. For FoamDielExt and FoamDielInt, this angle is 45°, while for FoamTwinDiel, it is 20°. This means that there are 8 transmitters for FoamDielExt and FoamDielInt, while there are 18 transmitters for FoamTwinDiel.

### Supplementary Material—S3.3 Settings for 3D Dataset

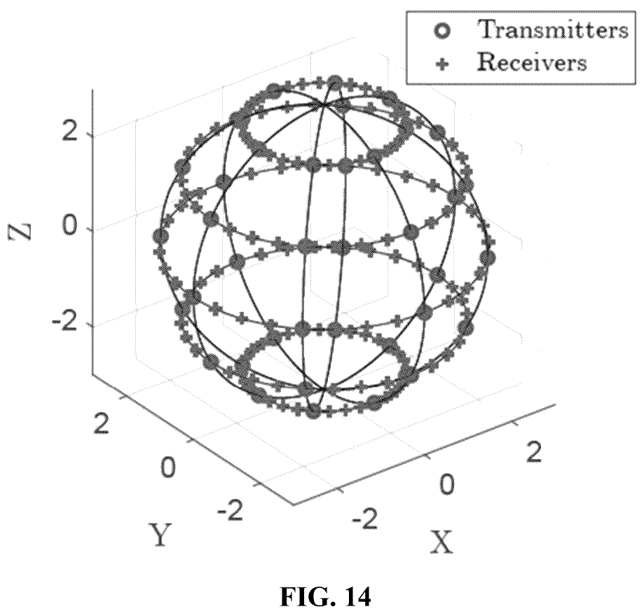

The proposed method is also tested on the 3D MNIST dataset. The permittivity of the objects is set to be 2. The operating frequency is set f=400 MHz, and the ROI is set as a cube with the size of 2×2×2 m³. FIG. 14 shows positions of the transmitters and receivers on the measurement sphere for 3D dataset. As shown in FIG. 14, there are 40 transmitters and 160 receivers. The transmitters and receivers are all located at the sphere of radius 3 m around the target centered at the center of ROI. For the positions of transmitters, the azimuthal angle ranged from 0° to 315° with a 45° step, and the polar angle ranged from 30° to 150° with a 30° step. For the positions of receivers, the azimuthal angle ranged from 0° to 348.75° with an 11.25° step, and the polar angle ranged from 30° to 150° with a 30° step.

### Supplementary Material—S4 Reproduction Details and Pseudocode

### Supplementary Material—S4.1 Reproduction Details

In this part, reproduction details and pseudocode of the proposed method are presented.

Additional network details: Two eight-layer MLPs with 256 channels and ReLU activations are used to individually predict the relative permittivity εᵣ and induced current J. The difference between these two networks lies in the last layer. The output dimension of the last layer is 1 for relative permittivity, and 2 for induced current, representing the real and imaginary parts, respectively.

Computational details: Formulas to predict the relative permittivity and induced current for each transmitter are developed in the present disclosure. Specifically, for p-th transmitter, it can be obtained that the predicted scattered fields is expressed as:

$${\hat{E}}_{p}^{s} = {G}_{S} \cdot {J}_{p} , p = 1 , 2 , … \qquad Eq . ( S9 )$$

where G_{S} is a Nᵣ×M² complex matrix, denoting the discrete Green's function, and Jₚ and Êₚ^{s} are complex vectors of dimensions M² and N^{r}, denoting the discrete induced current and predicted scattered fields inspired by p-th transmitter, respectively. Nₜ and Nᵣ are the total numbers of transmitters and receivers, respectively, and M×M is the size of the discretized subunits of ROI. Jₚ is the discrete induced current directly sampled from H_{ϕ}. To calculate the mismatch of the state equation, it can be obtained that the predicted induced current Ĵₚ is expressed as:

$${\hat{J}}_{p} = Diag ( ξ ) \cdot {E}_{p}^{i} + Diag ( ξ ) \cdot {G}_{D} \cdot {J}_{p} , p = 1 , 2 , … \qquad Eq . ( S10 )$$

where ξ is a vector of dimension M², reshaped from spatially queried network F_{θ}, representing the contrast value. Ĵₚ is a complex vector of dimension M², indicating the induced current computed via the mathematical correlation. Diag(ξ) is the diagonal matrix of contrast function with dimension M²×M². G_{D} is also a discrete Green's function with dimension M²×M².

Although the computation formulas for each transmitter are provided, when calculating Eq. (S9) and Eq. (S10) for all Nt transmitters, a more efficient approach is used. To be precise, equations in Eq. (S9) and Eq. (S10) can be rewritten as:

$${\hat{E}}_{all}^{s} = {G}_{S} \cdot {J}_{all} \qquad Eq . ( S11 )$$

$$and$$

$${\hat{J}}_{all} = Diag ( ξ ) \cdot {E}_{all}^{i} + Diag ( ξ ) \cdot {G}_{D} \cdot {J}_{all} \qquad Eq . ( S12 )$$

$$where$$

$${\hat{E}}_{all}^{s} = [ {\hat{E}}_{1}^{s} , {\hat{E}}_{2}^{s} , … , {\hat{E}}_{{N}_{t}}^{s} ] \qquad Eq . ( S13 )$$

$${J}_{all} = [ {J}_{1} , {J}_{2} , … , {J}_{{N}_{t}} ] \qquad Eq . ( S14 )$$

$${\hat{J}}_{all} = [ {\hat{J}}_{1} , {\hat{J}}_{2} , … , {\hat{J}}_{{N}_{t}} ] \qquad Eq . ( S15 )$$

$${E}_{p}^{i} = [ {E}_{1}^{i} , {E}_{2}^{i} , … , {E}_{{N}_{t}}^{i} ] \qquad Eq . ( S16 )$$

In Eq. (S11) and Eq. (S12), Êₛ is a matrix of dimension N^{r}×N^{t}, containing the scattered fields referring to all transmitters. Jₐₗₗ, Ĵₐₗₗ, and Eⁱ are all M²×N^{t} matrices. Therefore, during implementation, the loss functions can be equivalently rewritten as:

$${ℒ}_{data} = \frac{{‖ {\hat{E}}_{all}^{s} - {E}_{all}^{s} ‖}_{2}^{2}}{{‖ {E}_{all}^{s} ‖}_{2}^{2}} \qquad Eq . ( S17 )$$

$$and$$

$${ℒ}_{data} = \frac{{‖ {\hat{J}}_{all} - {J}_{all} ‖}_{2}^{2}}{{‖ Diag ( ξ ) \cdot {E}_{all}^{i} ‖}_{2}^{2} + Δ} \qquad Eq . ( S18 )$$

where E^{s} is the ground truth measured by receivers in a matrix form, Δ denotes a small number to improve stability by preventing the denominator from being zero, and ∥·∥₂ denotes the matrix 2-norm.

Calculation of Green's functions: The two-dimensional scalar Green's function can be expressed as:

$$g ( x , {x}^{′} ) = \frac{i}{4} {H}_{0}^{( 1 )} ( {k}_{0} \vert x - {x}^{′} \vert ) \qquad Eq . ( S19 )$$

where H⁽¹⁾(·) is the zeroth order Hankel function of the first kind, k₀=2π/λ₀ is the wavenumber in free space, and λ₀ is the wavelength in free space. x and x′ are the coordinates of two corresponding positions.

The method of moment (MOM) is used with the pulse basis function and the delta testing function to discretize the domain D into M×M subunit, and the centers of subunits are located at xₙ with n=1, 2, . . . , M². Then, this continuous Green's function can be discretized into matrix G_{D} and G_{S}, respectively. The element in the n-th row and n′-th column of the M×M matrix G_{S} can be obtained as:

$${G}_{D} ( n , {n}^{′} ) = {k}_{0} {A}_{{n}^{′}} g ( {x}_{n} , {x}_{{n}^{′}} ) , n = 1 , 2 … , {M}^{2} , {n}^{′} = 1 , 2 , … , {M}^{2} \qquad Eq . ( S20 )$$

where Aₙ′ is the area of the n′-th subunits. Similarly, the element in the q-th row and n′-th column of the Nᵣ×M matrix G_{S} can be obtained as:

$${G}_{S} ( q , {n}^{′} ) = {k}_{0} {A}_{{n}^{′}} g ( {x}_{q} , {x}_{{n}^{′}} ) , q = 1 , 2 … , {N}_{t} , {n}^{′} = 1 , 2 , … , {M}^{2} \qquad Eq . ( S21 )$$

The discretized forms of Green's function can then be used in the calculations in Eq. (S9) to Eq. (S12).

Preprocessing for real-world dataset: To handle real-world and synthetic data in a unified manner, the real-world data is calibrated before using it. The calibration of real-world scattering field data can be conducted by multiplying those data with a complex coefficient. The complex coefficient is derived by dividing the measured incident field by the simulated incident field at the receiver located opposite the source.

Implementation details of baselines: For Physics-Net, the known formulation is referred to get the regularization parameter β, and the backbone architecture thereof is introduced as well. For network optimization, the SDG optimizer is used with momentum 0.99, a learning rate 5×10⁻⁶ that decays following the step scheduler with step size 20 and decay factor 0.5. For PGAN, the structure of the generator and discriminator follows the architecture according to a research. The hyperparameters suggested in this research is applied as well. The number of hidden layers used in perceptual adversarial loss is M_{d}=1, weight parameters β=0.01 and γ=4.0 for the loss function of the generator, and m=0.2 for the loss function of the discriminator. For network optimization, the Adam optimizer is employed with default values β₁=0.9, β₂=0.999, ϵ=10⁻⁸, and a learning rate 2×10⁻⁴ that decays following the linear scheduler after the first 20 epochs during optimization. All the hyperparameters are the ones suggested by the research. The codes of BPS and CS-Net are directly used to ensure the fairness of the evaluation.

### Supplementary Material—S4.2 Pseudocode

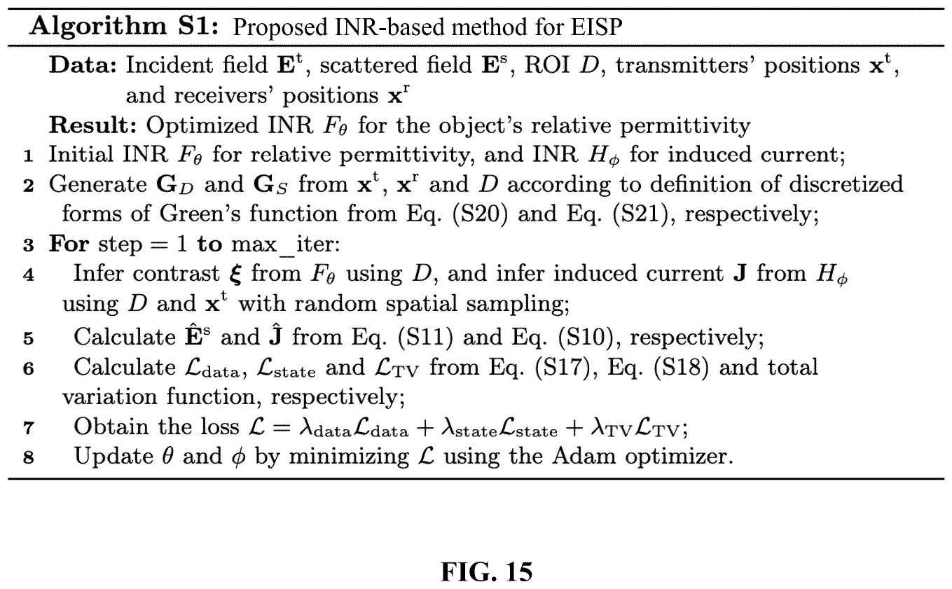

A pseudocode is provided to offer a detailed and step-by-step understanding of the proposed approach, as shown in FIG. 15.

### Supplementary Material—S5 Additional Results

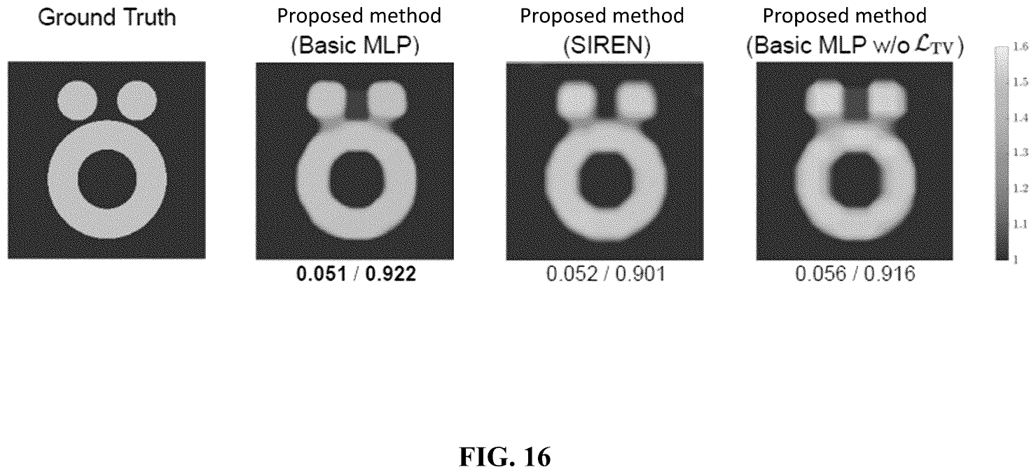

Ablation study on different backbones: Two different backbones for INR are introduced, namely basic MLP with ReLU activations and SIREN. These two structures are both based on fully connected networks to represent continuous mappings, so choosing either network does not affect the provided proof of the applicability of INR. The results for different backbones are shown in FIG. 16. FIG. 16 shows ablation study results including comparison with different backbones and comparison with and without variation loss LTV. The results of a standard test case in EISP are shown. The pixel values in the images indicate the values of the relative permittivity. RRMSE/SSIM values are shown below the illustration. From the results, both basic MLP and SIREN can accurately reconstruct the internal structures of objects. The reconstruction quality using basic MLP is slightly better than that of SIREN.

Some previous studies point out that SIREN has certain drawbacks in terms of its implementation. First, it cannot utilize the speed-up techniques of INRs, such as the one described in Instant-NGP. Second, their custom activations are still not compatible with accelerator hardware in certain devices. Therefore, basic MLP is chosen as the backbone of INR in the present disclosure.

Ablation study on variation loss: The impact of total variation loss LTV is further tested for relative permittivity ξ on the results. The results with and without LTV are shown in FIG. 16. The results indicate that LTV improves the proposed model's performance.

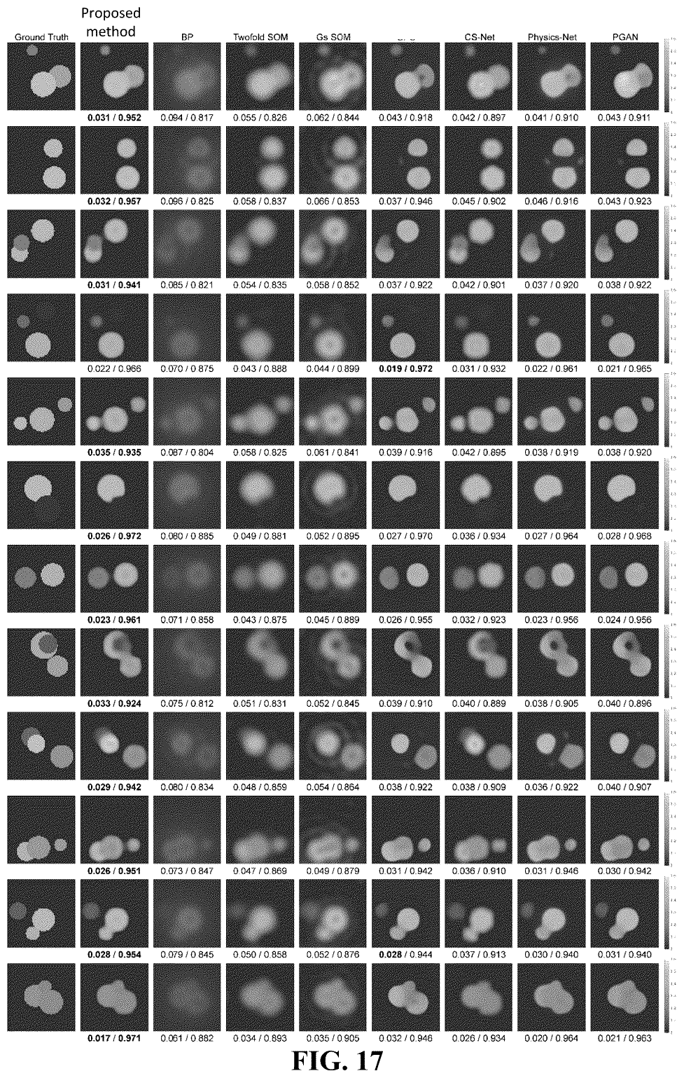

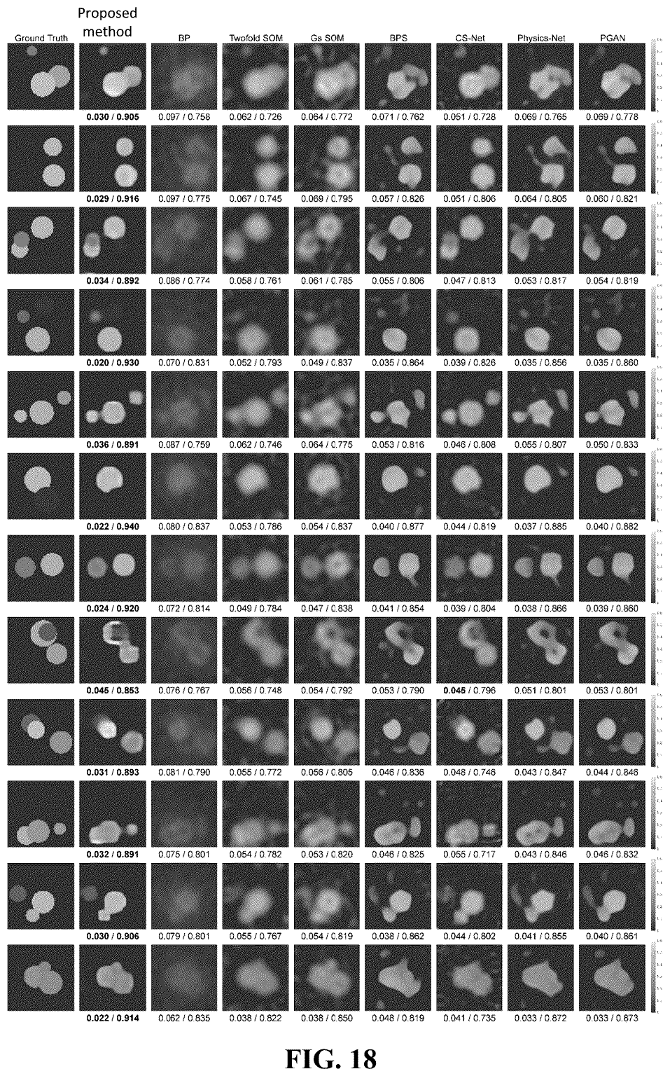

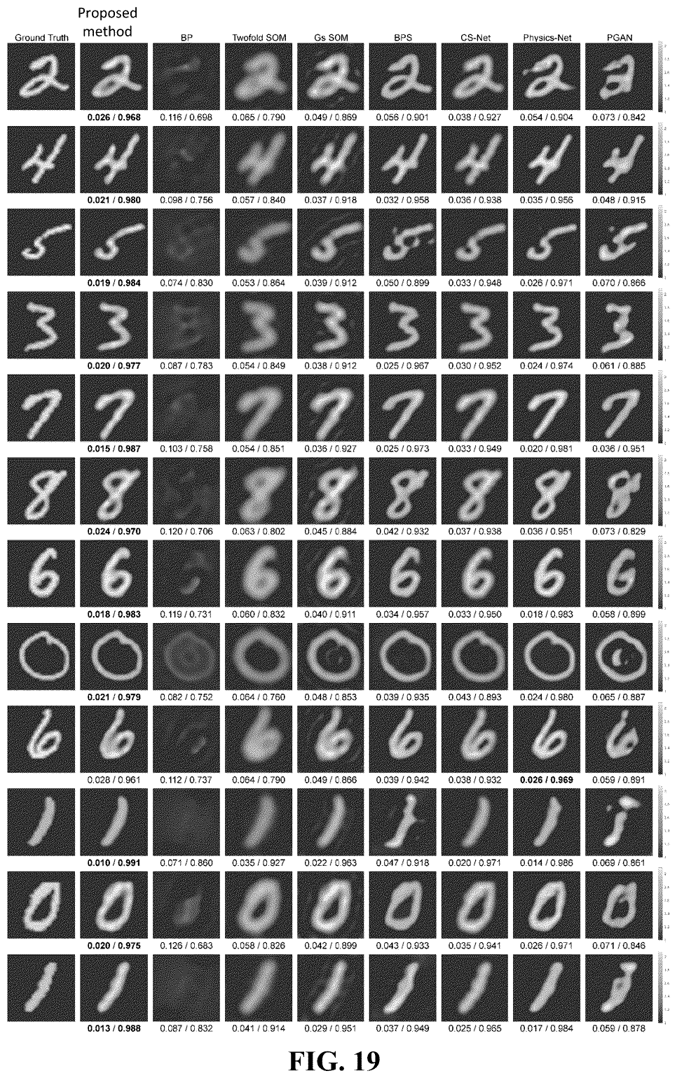

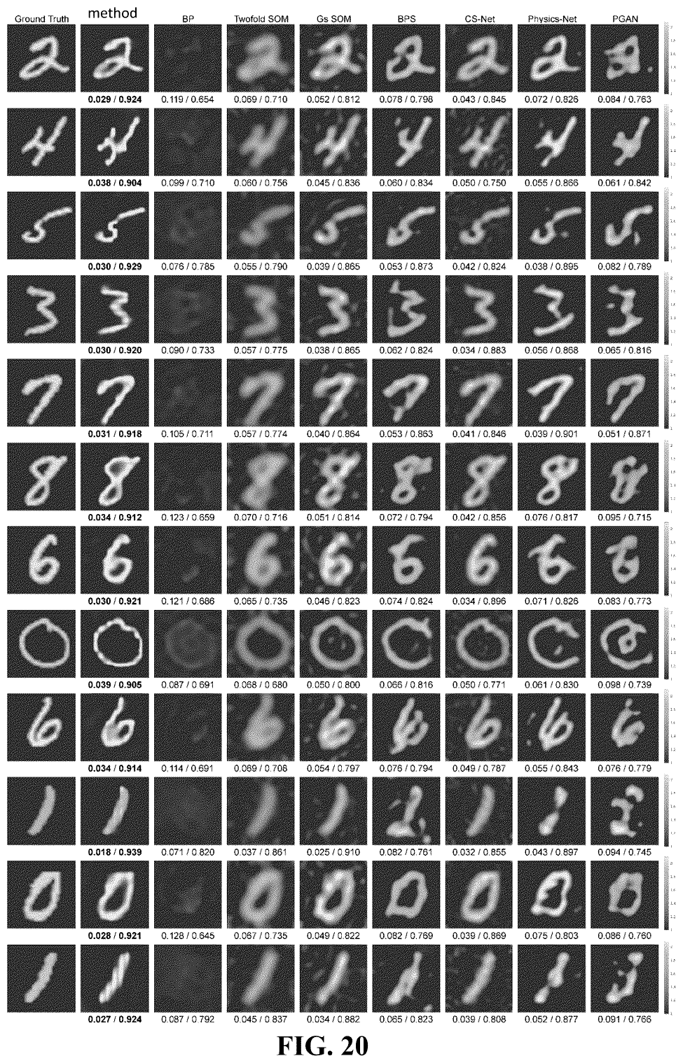

Additional qualitative and quantitative results: More qualitative and quantitative results are presented on Circular-cylinder dataset and MNIST dataset under different noise levels, as shown in FIG. 17 to FIG. 20. FIG. 17 shows samples obtained from Cicrular-cylinder dataset under 5% noise level. From left to right: ground truth, results obtained by the proposed method, BP, Twofold SOM, Gs SOM, BPS, CS-Net, Physics-Net, and PGAN, RRMSE/SSIM values are shown below each figure. FIG. 18 shows samples obtained from synthetic Cicrular-cylinder dataset under 30% noise level. From left to right: ground truth, results obtained by the proposed method, BP, Twofold SOM, Gs SOM, BPS, CS-Net, Physics-Net, and PGAN, RRMSE/SSIM values are shown below each figure. FIG. 19 shows samples obtained from synthetic MNIST dataset under 5% noise level. From left to right: ground truth, results obtained by the proposed method, BP, Twofold SOM, Gs SOM, BPS, CS-Net, Physics-Net, and PGAN, RRMSE/SSIM values are shown below each figure. FIG. 20 shows samples obtained from synthetic MNIST dataset under 30% noise level. From left to right: ground truth, results obtained by the proposed method, BP, Twofold SOM, Gs SOM, BPS, CS-Net, Physics-Net, and PGAN, RRMSE/SSIM values are shown below each figure. The proposed method reaches the highest visual quality compared with other baseline methods.

The above results validate that the proposed solution contributes to the field of Electromagnetic Inverse Scattering Problems. The following provides a detailed description of how the proposed solution operates in hardware.

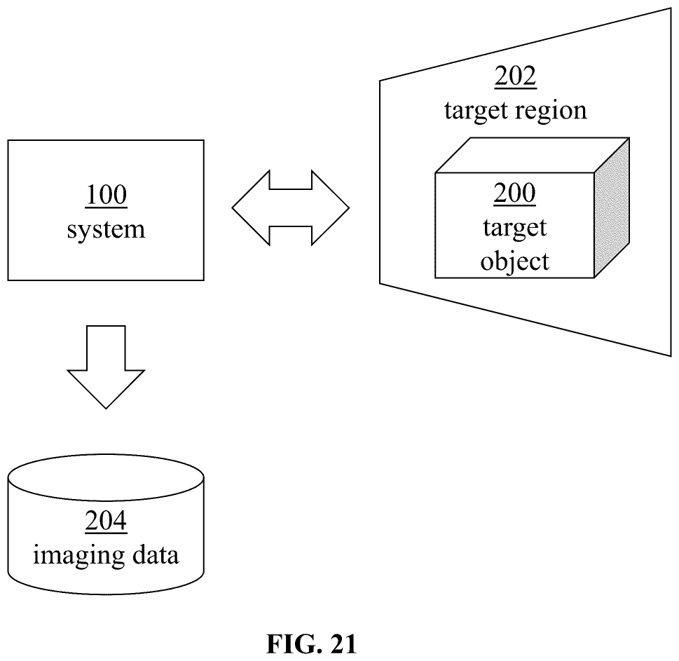

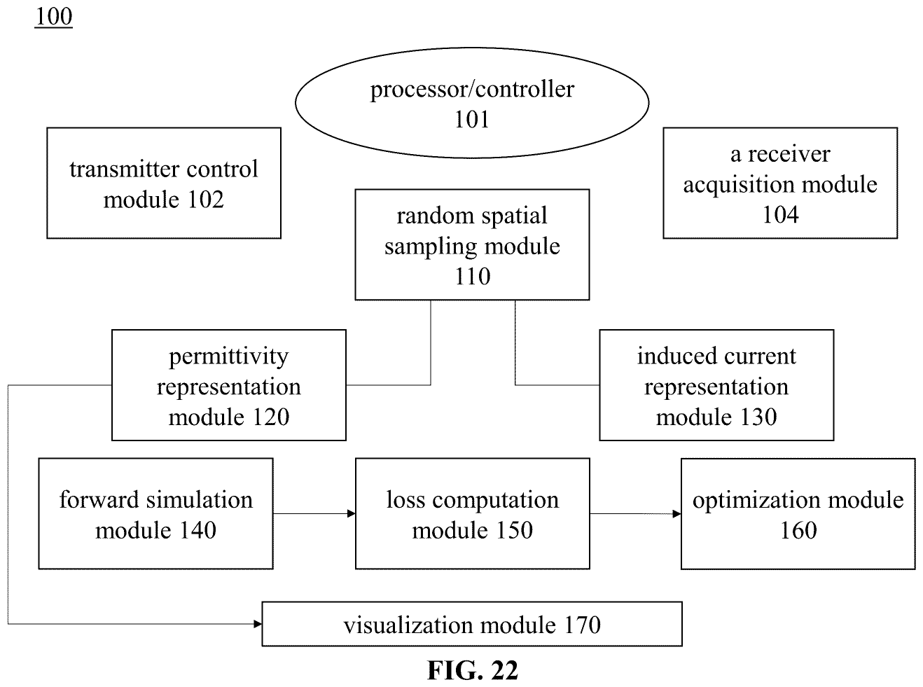

FIG. 21 is a schematic diagram illustrating a system 100 performing its task and producing an output result according to one embodiment of the present invention. FIG. 22 is a block diagram illustrating an architecture of a system 100 for inverse scattering image reconstruction using INR according to one embodiment of the present invention.

The system 100 is configured to predict an internal relative permittivity distribution of a target object 200 (e.g., a physical item) in a target region 202 and to output corresponding imaging data 204 representing the target object's internal structure within the target region 202. In some embodiments, the imaging data 204 may include a spatially resolved map of relative permittivity values, which may be visualized as a high-resolution image to facilitate interpretation of material composition or internal geometry of the target object. As such, the reconstruction process enables non-invasive imaging of internal features based on external electromagnetic measurements.

The system 100 includes a transmitter control module 102, a receiver acquisition module 104, a random spatial sampling module 110, a permittivity representation module 120, an induced current representation module 130, a forward simulation module 140, a loss computation module 150, and an optimization module 160. The system 100 includes a processor or controller 101 configured to interface with the various components and operate as an intermediary for issuing control instructions, thereby coordinating the actions among the components. The connections may be implemented using wired links or wireless communication technologies.

The transmitter control module 102 is configured to emit known electromagnetic signal data directed toward the target region. The incident signals by the transmitter control module 102 interact with the internal structure of the target object and result in electromagnetic scattering behavior. The transmitter control module 102 may include one or more electromagnetic wave generators configured to produce and emit signal data at predefined frequencies, waveforms, or pulse sequences. The transmitter control module 102 may include hardware components such as signal generators, frequency synthesizers, power amplifiers, and antenna arrays. In some embodiments, the emitted signals from the transmitter control module 102 may be continuous wave, pulsed, or modulated.

The receiver acquisition module 104 is configured to collect scattered signal data at multiple spatial locations surrounding the target region. The acquired data represent the observable effects caused by interactions between the emitted signals provided by the transmitter control module 102 and the target object's internal material properties. The receiver acquisition module 104 may include one or more electromagnetic field sensors configured to detect scattered signal data at designated spatial locations. In some embodiments, the receiver acquisition module 104 may be further configured to sample scattered signal amplitudes, phases, or time-domain waveforms, and to digitize such data for downstream processing.

The random spatial sampling module 110 is configured to generate spatial coordinate data distributed across the target region. The generated coordinates are randomly selected based on a probabilistic distribution, such as a Gaussian distribution centered around grid locations within the target region (i.e., the probabilistic distribution centered around predefined grid locations). The coordinate data output by the random spatial sampling module 110 may be provided as input to one or more downstream modules for purposes of internal parameter estimation and representation learning.

The permittivity representation module 120 is configured to generate a spatial representation of the relative permittivity distribution associated with the target region. The permittivity representation module 120 is implemented using a MLP that receives spatial coordinate data generated by the random spatial sampling module 110 and outputs corresponding relative permittivity data. At the start of operation, the MLP within the permittivity representation module 120 is randomly initialized and generates preliminary relative permittivity values without prior knowledge of the target object's internal structure. During iterative optimization, these values are progressively refined based on discrepancies between simulated and measured scattering responses. The updated permittivity values are provided to the induced current representation module 130 and the forward simulation module 140 to support physical modeling and signal prediction.

The induced current representation module 130 is configured to model an internal electromagnetic response of the target object resulting from its interaction with incident electromagnetic signals. The induced current representation module 130 is implemented using a MLP that receives spatial coordinate data from the random spatial sampling module 110 and transmitter location data from the transmitter control module 102. Based on these inputs, the MLP within the induced current representation module 130 outputs induced current data representing the object's internal response characteristics. In some embodiments, the induced current representation module 130 may further access relative permittivity data generated by the permittivity representation module 120 to maintain physical consistency in the response modeling, during a process of training or inference in which the induced current representation module 130 generates the induced current data based on both spatial coordinates and permittivity information. The induced current data are provided to the forward simulation module 140 for generating predicted scattering signals.

The use of MLPs in the permittivity representation module 120 and the induced current representation module 130 provides a number of advantages in the concept of inverse scattering image reconstruction. MLPs offer a flexible and continuous function approximation capability, allowing relative permittivity and induced current distributions to be represented without requiring fixed spatial discretization or prior knowledge of the object's structure. This continuous representation enables high-resolution querying at arbitrary coordinates and avoids the limitations associated with grid-based parameterizations. Furthermore, by decoupling the modeling of permittivity and induced current into two separately trainable networks, the system 100 reduces computational complexity and allows for more interpretable and modular learning. The MLP-based architecture also facilitates gradient-based optimization, making it compatible with modern learning frameworks and highly efficient for end-to-end training in forward-estimation workflows.

The forward simulation module 140 is configured to receive the relative permittivity data from the permittivity representation module 120 and the induced current data from the induced current representation module 130. The forward simulation module 140 is further configured to simulate predicted scattered signal data corresponding to multiple receiver locations. The receiver locations used for simulation by the forward simulation module 140 may be defined in accordance with the spatial layout of the receiver acquisition module 104, such that the predicted scattered signal data are generated at positions corresponding to the actual measurement points. This enables direct comparison between simulated and observed signals during loss computation.

In some embodiments, the forward simulation module 140 utilizes the relative permittivity data to determine contrast characteristics across the region of interest, and applies the induced current data as a modeled internal source term. Based on these inputs, the forward simulation module 140 performs numerical computation that propagates the electromagnetic response through a discretized domain using predefined Green's function kernels or equivalent field propagation operators. The resulting scattered field signals at predefined receiver locations are computed as the predicted scattered signal data. This simulation reflects forward electromagnetic behavior governed by physical scattering relationships, and enables prediction of observable field responses without performing inverse estimation. The predicted scattered signal data generated by the forward simulation module 140 are transmitted to the loss computation module 150.

The loss computation module 150 is configured to compare the predicted scattered signal data generated by the forward simulation module 140 with the actual measured data acquired by the receiver acquisition module 104. A data loss is computed by the loss computation module 150 to quantify the discrepancy between predicted and true scattered responses. A state loss is computed by comparing the induced current data generated by the induced current representation module 130 with induced current data inferred indirectly through permittivity-based estimation. Both the data loss and the state loss values are transmitted to the optimization module 160 for parameter refinement.

The optimization module 160 is configured to receive the data loss and state loss from the loss computation module 150 and to iteratively update internal parameters of the permittivity representation module 120 and the induced current representation module 130 via a gradient-based optimization process. During each training iteration, the optimization module 160 computes gradients of the loss functions with respect to the parameters of the respective multilayer perceptrons and applies parameter adjustments using an optimization algorithm, such as stochastic gradient descent or adaptive moment estimation. The iterative process continues across multiple training cycles, in which the predicted scattering behavior is gradually aligned with the measured scattering responses acquired by the receiver acquisition module 104. As training progresses, the generated relative permittivity and induced current data become increasingly consistent with the true internal electromagnetic properties of the target object.

Upon convergence (e.g., which is defined as a condition where the loss metrics fall below predefined thresholds or reach steady-state values), the trained permittivity representation module 120 may be queried with a dense set of spatial coordinates covering the entire region of interest. In response, the permittivity representation module 120 outputs relative permittivity data corresponding to each spatial coordinate, thereby forming a continuous or grid-based representation of the object's internal material distribution.

The system 100 may further include a visualization module 170. The complete set of permittivity data is then supplied to a visualization module by the permittivity representation module 120, in which the visualization module 170 is configured to generate a final image representing the spatial variation of the relative permittivity across the region. The generated image reflects the electromagnetic properties of the target object and is reconstructed based on data derived entirely from the trained neural representation, without direct measurement. The resulting visual representation enables interpretation of the internal structure of the target object in a high-resolution, non-invasive manner.

By this configuration, in operation, object detection and internal characterization are carried out through a coordinated process involving multiple modules. The process begins with the transmitter control module 102 emitting known electromagnetic signal data into a defined target region. These incident signals interact with the internal structure of a target object located within the region, resulting in electromagnetic scattering. The receiver acquisition module 104 is configured to collect the resulting scattered signal data from multiple spatial locations surrounding the region. The measured data reflect the material-dependent response of the object to the emitted signals and are used as reference observations.

Concurrently, the random spatial sampling module 110 generates spatial coordinate data, which are provided to the permittivity representation module 120 and the induced current representation module 130. The permittivity representation module 120 and the induced current representation module 130, implemented as trainable MLPs, output predicted relative permittivity and induced current data, respectively.

The forward simulation module 140 utilizes the relative permittivity data to characterize electromagnetic contrast within the target region and applies the induced current data as an internal excitation source. Based on these inputs, the forward simulation module 140 performs numerical computations that simulate electromagnetic field propagation through a discretized spatial domain. The simulation is carried out at specific locations corresponding to the physical receiver positions defined by the configuration of the receiver acquisition module 104, thereby producing predicted scattered signal data that are spatially aligned with the measured data.

The predicted scattered signal data provided by the forward simulation module 140 and the collected scattered signal data provided by the receiver acquisition module 104 are then compared by the loss computation module 150 to compute a data loss. Additionally, a state loss is computed by comparing the induced current data generated by the induced current representation module 130 with current data indirectly inferred from the permittivity-based estimation.

Based on the resulting loss values, the optimization module 160 iteratively adjusts the internal parameters of the neural representation modules. Through successive training cycles, the system 100 aligns the predicted electromagnetic behavior with the observed data, enabling the recovery of a relative permittivity distribution that accurately reflects the internal structure of the target object. Upon convergence, the trained model is queried to produce a complete set of permittivity data, which are then visualized by the visualization module 170 as a high-resolution image of the object's interior.

As discussed above, a system and method for solving electromagnetic inverse scattering problems (EISP) using an implicit learning-based framework has been presented. The system represents the unknown relative permittivity distribution of a target object as a trainable function, implemented via a multilayer perceptron (MLP), and optimizes this representation through a forward simulation and loss-driven refinement process. A dual-MLP structure is employed to separately model relative permittivity and induced current, effectively reducing computational complexity while preserving physical consistency. Experimental evaluations on both synthetic and real-world datasets confirm the effectiveness of the proposed approach in producing accurate, high-resolution reconstructions of internal material structures.

The functional units and modules of the system in accordance with the embodiments disclosed herein may be embodied in hardware or software. That is, the claimed system may be implemented entirely as machine instructions or as a combination of machine instructions and hardware elements. Hardware elements include, but are not limited to, computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

The system may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The system may also be configured as distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for inverse scattering image reconstruction using implicit neural representations (INR), comprising:
a transmitter control module configured to emit known electromagnetic signal data directed toward a target region containing a target object;
a receiver acquisition module configured to collect scattered signal data resulting from interactions between the known electromagnetic signal data and internal features of the target object;
a random spatial sampling module configured to generate spatial coordinate data distributed across the target region;
a permittivity representation module configured to receive the spatial coordinate data and output relative permittivity data, wherein the permittivity representation module is implemented using a first multilayer perceptron (MLP);
an induced current representation module configured to receive the spatial coordinate data and transmitter location data and to output induced current data, wherein the induced current representation module is implemented using a second MLP;
a forward simulation module configured to receive the relative permittivity data and the induced current data and to generate predicted scattered signal data at multiple receiver locations;
a loss computation module configured to compare the predicted scattered signal data with the scattered signal data collected by the receiver acquisition module and to compute a data loss; and
an optimization module configured to receive the data loss and to iteratively update internal parameters of the first and second MLPs via a gradient-based optimization process, wherein, upon convergence, the first MLP within the permittivity representation module is configured to output a spatial distribution of relative permittivity values representing an internal structure of the target object.

2. The system according to claim 1, wherein the loss computation module is further configured to compute a state loss by comparing the induced current data generated by the induced current representation module with additional induced current data inferred indirectly through the permittivity representation module.

3. The system of claim 1, further comprising a visualization module configured to receive the spatial distribution of the relative permittivity values from the permittivity representation module and to generate an image representing the spatial distribution with internal electromagnetic properties of the target object.

4. The system of claim 1, wherein the convergence is defined as a condition in which one or more loss metrics fall below predefined thresholds or reach steady-state values during iteratively updating the internal parameters of the first and second MLPs.

5. The system of claim 4, wherein, upon the convergence, the permittivity representation module is further configured to be queried with a set of spatial coordinates to output a complete relative permittivity distribution across the target region.

6. The system of claim 1, wherein the random spatial sampling module is configured to generate the spatial coordinate data based on a probabilistic distribution centered around predefined grid locations.

7. The system of claim 1, wherein the transmitter control module comprises one or more signal generators, frequency synthesizers, power amplifiers, and antenna arrays.

8. The system of claim 1, wherein the receiver acquisition module comprises one or more electromagnetic field sensors configured to detect scattered signal amplitudes, phases, or time-domain waveforms.

9. The system of claim 1, wherein the induced current representation module is further configured to receive the relative permittivity data from the permittivity representation module to maintain physical consistency in response modeling, during a process of training or inference in which the induced current representation module generates the induced current data based on both spatial coordinates and permittivity information.

10. A method for inverse scattering image reconstruction using implicit neural representations (INR), comprising:
emitting known electromagnetic signal data directed toward a target region containing a target object by a transmitter control module;
collecting scattered signal data resulting from interactions between the known electromagnetic signal data and internal features of the target object by a receiver acquisition module;
generating spatial coordinate data distributed across the target region by a random spatial sampling module;
receiving the spatial coordinate data and accordingly outputting relative permittivity data by a permittivity representation module which is implemented using a first multilayer perceptron (MLP);
receiving the spatial coordinate data and transmitter location data and accordingly outputting induced current data by an induced current representation module which is implemented using a second MLP;
receiving the relative permittivity data and the induced current data and accordingly generating predicted scattered signal data at multiple receiver locations by a forward simulation module;
comparing, by a loss computation module, the predicted scattered signal data with the scattered signal data collected by the receiver acquisition module, thereby computing a data loss;
receiving the data loss and iteratively updating internal parameters of the first and second MLPs via a gradient-based optimization process by using an optimization module; and
outputting, by the first MLP within the permittivity representation module, a spatial distribution of relative permittivity values representing an internal structure of the target object upon convergence.

11. The method according to claim 10, further comprising:
computing, by using the loss computation module, a state loss by comparing the induced current data generated by the induced current representation module with additional induced current data inferred indirectly through the permittivity representation module.

12. The method according to claim 10, further comprising:
receiving, by a visualization module, the spatial distribution of the relative permittivity values from the permittivity representation module; and
generating, by the visualization module, an image representing the spatial distribution with internal electromagnetic properties of the target object.

13. The method according to claim 10, wherein the convergence is defined as a condition in which one or more loss metrics fall below predefined thresholds or reach steady-state values during iteratively updating the internal parameters of the first and second MLPs.

14. The method according to claim 13, further comprising:
upon convergence, querying the permittivity representation module with a set of spatial coordinates to output a complete relative permittivity distribution across the target region.

15. The method according to claim 10, further comprising:
generating, by the random spatial sampling module, the spatial coordinate data based on a probabilistic distribution centered around predefined grid locations.

16. The method according to claim 10, wherein the transmitter control module comprises one or more signal generators, frequency synthesizers, power amplifiers, and antenna arrays.

17. The method according to claim 10, wherein the receiver acquisition module comprises one or more electromagnetic field sensors configured to detect scattered signal amplitudes, phases, or time-domain waveforms.

18. The method according to claim 10, further comprising:
receiving, by the induced current representation module, the relative permittivity data from the permittivity representation module to maintain physical consistency in response modeling, during a process of training or inference in which the induced current representation module generates the induced current data based on both spatial coordinates and permittivity information.
